(19) United States
(12) Patent Application Publication
(10) Pub. No.: US 2022/0009289 A1
(43) Pub. Date: Jan. 13, 2022

(54) TIRE

(71) Applicant: BRIDGESTONE CORPORATION, Tokyo (JP)

(72) Inventors: Hiroshi TAKADA, Chuo-ku, Tokyo (JP); Shingo HONDA, Chuo-ku, Tokyo (JP)

(73) Assignee: BRIDGESTONE CORPORATION, Tokyo (JP)

(21) Appl. No.: 17/413,308

(22) PCT Filed: Dec. 13, 2019
(86) PCT No.: PCT/JP2019/048999

§ 371 Date: Jun. 11, 2021

(30) Foreign Application Priority Data
Dec. 14, 2018 (JP) 2018-234252

(51) Int. Cl. B60C 9/22; B60C 15/06

(52) U.S. Cl. CPC B60C 9/22; B60C 9/2003; B60C 15/06

(57) ABSTRACT

The belt layer (50) of the pneumatic tire (10) includes one inclined belt (50 A) having an inclined cord inclined with respect to the tire width direction, and a circumferential belt (50 B) disposed outside the tire radial direction of the inclined belt (50 A) and having a circumferential cord (52) wound along the tire circumferential direction. The inclined cord and the circumferential cord are formed of a predetermined organic fiber. The tread thickness (T1) of the rubber forming the tread portion (20) along the tire radial direction at a tire equatorial line (CL) is 5 mm or less.

### TECHNICAL FIELD

The present invention relates to a tire suitably mounted on a solar car or the like, requiring low rolling resistance and light weight.

### BACKGROUND ART

A pneumatic tire (hereinafter abbreviated as tire), which can be suitably used for a solar car which is a vehicle driven by an electric motor utilizing solar cells as a power source, is known (see Patent Literature 1.).

The tire disclosed in the Patent Literature 1 comprises a crossing belt layer having two or less belts and a spiral belt (circumferential belt) having cords wound along the on the outside of the tire radial direction of the crossing belt layer.

With such a configuration, both the reduction of rolling resistance and the reduction of weight are achieved.

### CITATION LIST

### Patent Literature

[PTL 1] Japanese Unexamined Patent Application Publication No. 2000-190706

### SUMMARY OF INVENTION

According to tire as described above, it is possible to achieve both a reduction in rolling resistance and a reduction in weight, but further improvement has been required.

In addition, in order to reduce the weight, if simplification of an internal structure such as a crossing belt layer is adopted, it is likely to cause a puncture, thereby reducing durability.

Accordingly, an object of the present invention is to provide a tire having improved durability against puncture while reducing rolling resistance and weight.

One aspect of the present invention is a tire (pneumatic tire 10) including a tread portion (tread portion 20) in contact with a road surface, a tire side portion (tire side portion 30) continuous to the tread portion and positioned inside in a tire radial direction of the tread portion, a bead portion (bead portion 60) continues to the tire side portion and positioned inside in the tire radial direction of the tire side portion, and a belt layer (belt layer 50) disposed inside the tire radial direction of the tread portion. The belt layer includes a single inclined belt (inclined belt 50 A) having an inclined cord (inclined cord 51) inclined with respect to the tire width direction, and a circumferential belt (circumferential belt 50 B) disposed outside the tire radial direction of the inclined belt and having a circumferential cord (circumferential cord 52) wound along the tire circumferential direction. The inclined cord and the circumferential cord are formed of a predetermined organic fiber, and a tread thickness (tread thickness T1) of a rubber forming the tread portion along a tire radial direction at a position of a tire equatorial line is 5 mm or less.

### BRIEF DESCRIPTION OF DRAWINGS

FIG. 1 is a cross-sectional view of a pneumatic tire 10 along tire width direction and tire radial direction.

FIG. 2 is a top view (tread surface view) of a part of a carcass 40 and a belt layer 50.

### DESCRIPTION OF EMBODIMENTS

Embodiments will be described below with reference to the drawings. The same functions and configurations are denoted by the same or similar reference numerals, and description thereof will be omitted as appropriate.

### (1) Overall Structure of Tire

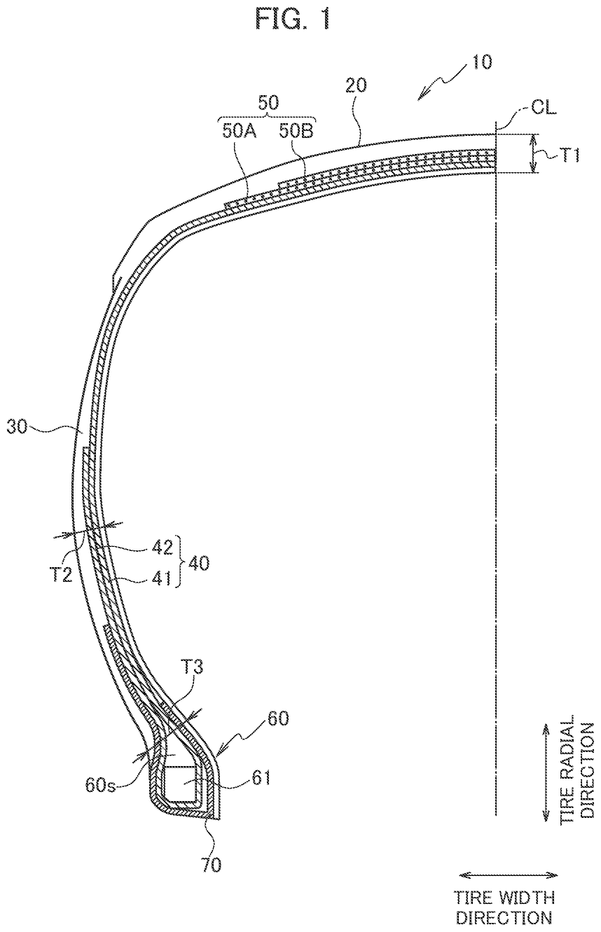

FIG. 1 is a partial sectional view of the pneumatic tire 10 according to the present embodiment. Specifically, FIG. 1 is a cross-sectional view of the pneumatic tire 10 taken along the tire width direction and the tire radial direction. In FIG. 1, only one side of the tire equatorial line CL is shown with respect to the pneumatic tire 10. In FIG. 1, sectional hatching is partially omitted.

The pneumatic tire 10 is used for a light vehicle such as a solar car which is a vehicle driven by an electric motor utilizing a solar cell as a power source. In particular, it can be suitably used for a racing solar car.

In this embodiment, the pneumatic tire 10 has a diameter size of 16 inches and a tread width of 100 mm or less (For example, 75, 95 size). The specified internal pressure (air pressure) is about 500 to 600 kPa.

As shown in FIG. 1, the pneumatic tire 10 includes a tread portion 20, a tire side portion 30, a carcass 40, a belt layer 50, a bead portion 60, and a chafer 70.

The tread portion 20 is a portion in contact with a road surface. For the tread portion 20, rubber of an appropriate composition is used and a tread pattern (unillustrated) is formed based on characteristics and travelling conditions of a light vehicle such as a solar car to which the pneumatic tire 10 is mounted.

Solar cars (especially a racing solar car) are much lighter than standard passenger cars and mainly travel straight.

The thickness of rubber forming the tread portion 20 is thinner than that of a standard passenger car tire. In the present embodiment, a tread thickness T1 of a rubber forming the tread portion 20 along the tire radial direction at a position of the tire equatorial line CL is 5 mm or less. The tread thickness T1 is preferably 1.5 mm to 3.5 mm.

The distortion energy loss (tan δ) of the rubber forming the tread portion 20 at 30° C. is preferably 0.08 to 0.2.

The tire side portion 30 is continuous to the tread portion 20 and is positioned inside in the tire radial direction of tread portion 20. The tire side portion 30 is an area from the outer edge of the tire width direction of the tread portion 20 to the upper edge of the bead portion 60. The tire side portion 30 is sometimes referred to as a sidewall.

In the present embodiment, the thickness of the rubber forming the tire side portion 30 is also thinner than that of the standard passenger car tire. Specifically, the maximum thickness T2 of the rubber forming the tire side portion 30 is 3 mm or less.

Note that the maximum thickness T2 means a thickness along a straight line that is substantially perpendicular to the inner surface of the tire side portion 30 in a sectional view of the pneumatic tire 10 as shown in FIG. 1.

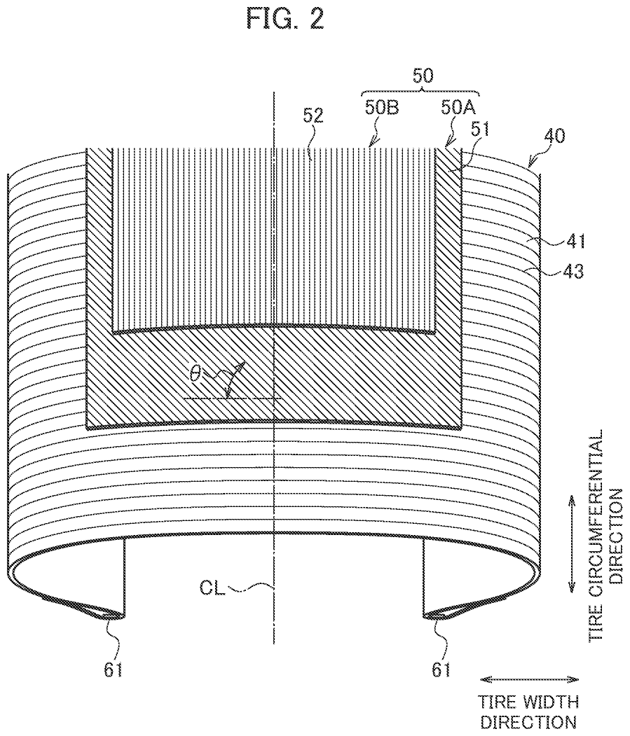

The carcass 40 forms the skeleton of the pneumatic tire 10. The carcass 40 is a radial structure having a carcass cord 43 (not shown in FIG. 1, see FIG. 2) radially disposed along a tire radial direction. The carcass 40 is formed of only 1 sheet (one layer).

However, the carcass 40 is not limited to a radial structure, and a bias structure in which a carcass cord is arranged so as to cross each other in the tire radial direction may be used.

The carcass 40 has a body portion 41 and a folded portion 42. The body portion 41 is provided over the tread portion 20, the tire side portion 30 and the bead portion 60, and is a portion until it is folded at a bead core 61.

The folding back portion 42 is a part continued to the body portion 41 and folded back to the outside of the tire width direction via the bead core 61.

The belt layer 50 is disposed inside the tire radial direction of the tread portion 20. The belt layer 50 is provided in an annular shape along the tire circumferential direction at outside the tire radial direction of the carcass 40.

In the present embodiment, the belt layer 50 includes an inclined belt 50 A and a circumferential belt 50 B.

The inclined belt 50 A is provided adjacent to the body portion 41 of the carcass 40 and outside the tire radial direction of the body portion 41. The inclined belt 50 A is similar to a crossing belt commonly provided in a belt layer having a radial structure (radial tire), but only one inclined belt 50 A is provided. That is, the inclined belt 50 A is not a crossing belt where the cords cross, but the cords are arranged so as to be inclined in one direction with respect to the tire width direction (alternatively, may be based on the tire radial direction) as will be described later.

The circumferential belt 50 B is provided adjacent to the inclined belt 50 A and outside the tire radial direction of the inclined belt 50 A. The circumferential belt 50 B is a kind of spiral belt in which a cord is wound along the tire circumferential direction.

The bead portion 60 is continuous to the tire side portion 30 and is positioned inside in the tire radial direction of tire side portion 30. The bead portion 60 has an annular shape and is engaged with a rim wheel (unillustrated).

The bead portion 60 has the bead core 61. The bead core 61 is an annular (ring) member extending to the tire circumferential direction and is formed of a metal (steel) cord.

The bead portion 60 has a bead filler-less structure in which placement of a bead filler is omitted between the body portion 41 and the folded portion 42 of the carcass 40. That is, in the standard passenger car tire or the like, a bead filler as a rigid member is widely provided in the wedge-shaped space 60 s outside the tire radial direction than the bead core 61 formed between the body portion 41 and the folded portion 42 of the carcass 40 for filling the space 60 s, but such a bead filler is not provided in the pneumatic tire 10.

The space 60 s may be simply a void or may be filled with rubber that flows out from the surroundings upon vulcanization of the raw pneumatic tire 10.

In the present embodiment, the thickness of the rubber forming the bead portion 60 is also thinner than that of the standard passenger car tire. Specifically, the maximum thickness T3 of the rubber forming the bead portion 60 is 13 mm or less.

Note that, similarly to the maximum thickness T2, the maximum thickness T3 means a thickness along a straight line substantially perpendicular to the inner surface of the bead portion 60 in a sectional view of the pneumatic tire 10 as shown in FIG. 1.

The chafer 70 is provided on the outer peripheral surface of the bead portion 60. The chafer 70 prevents the bead portion 60 from being abraded by the rim wheel. The chafer 70 is formed of a reinforcing cord of an organic fiber or the like.

### (2) Specific Composition of Belt Layer

FIG. 2 is a top view (tread surface view) showing a part of the carcass 40 and the belt layer 50. As shown in FIG. 2, the carcass 40 has a plurality of carcass cords 43 disposed along a radial direction.

The carcass cord 43 is covered with a rubber member. In this embodiment, the carcass cord 43 is formed by twisting two polyester fibers. The fineness of the carcass cord 43 is preferably 2500 dtex or less.

As described above, the belt layer 50 includes the inclined belt 50 A and the circumferential belt 50 B. That is, the belt layer 50 includes one inclined belt and one circumferential belt only.

The inclined belt 50 A has inclined cords 51 inclined to the tire width direction. Specifically, the inclined belt 50 A has a plurality of inclined cords 51 inclined with respect to the tire width direction (alternatively, based on tire radial direction).

The inclined cord 51 is covered with a rubber member, and the inclined cord 51 is arranged at approximately equal intervals with the adjacent inclined cord 51. In this embodiment, the inclined cord 51 is formed of nylon fibers. That is, the inclined cord 51 can be formed of a predetermined organic fiber. The fineness of the inclined cord 51 is preferably 1500 dtex or less.

The inclination angle θ of the inclination cord 51 with respect to the tire width direction is 35 degrees or more and 55 degrees or less. The inclination angle θ is preferably 40 degrees or more and 50 degrees or less.

The circumferential belt 50 B is provided outside the tire radial direction of the inclined belt 50 A. The circumferential belt 50 B has a circumferential cord 52 wound along the tire circumferential direction.

The circumferential cord 52 is wound a plurality of times along the tire circumferential direction from one end side to the other end side in the tire width direction. The circumferential cord 52 is also covered with a rubber member.

In this embodiment, the circumferential cord 52 is formed of aramid fibers. That is, the circumferential direction cord 52 can be formed of a predetermined organic fiber. The fineness of the circumferential direction cord 52 is preferably 2500 dtex or less.

The initial elastic modulus of the circumferential belt 50 B is preferably 1000 cN/tex or more. The initial elastic modulus means the elastic modulus of the pneumatic tire 10 when it is new.

### (3) Function and Effects

Next, the function and effects of the pneumatic tire 10 will be described. if the pneumatic tire 10 having the above-described structure is manufactured, and its durability against rolling resistance and puncture can be evaluated.

The evaluation conditions may be as follows.
Tire Size: 95/80 R 16
Applicable Rim Size: 3 J

In the rolling resistance test, the rolling resistance value is evaluated based on the travelling distance when the vehicle is coasting from a speed of 120 km/h with internal pressure set at 500 kPa and 600 kPa. The slip angle and camber angle of the vehicle are set to 0 degrees, and a load of 5 kN is applied to the tire.

In the puncture resistance test, the internal pressure is set at 500 kPa, and the energy value generated by pressing the sharp conical protrusion against the tread surface of the tire is evaluated.

As a result, it can be confirmed that the pneumatic tire 10 has low rolling resistance equivalent to, or better than, that of a conventional pneumatic tire of the same type, and that it has high puncture resistance.

As described above, the pneumatic tire 10 is provided with one inclined belt 50 A having the inclined cords 51 inclined with respect to the tire width direction and one circumferential belt 50 B having the circumferential cord 52 wound along the tire circumferential direction. The inclined cords 51 and the circumferential cord 52 are formed of organic fibers.

Furthermore, the tread thickness T1 is 5 mm or less.

By using the tread portion 20 having the simplified thin belt layer 50 structure and an organic fiber cord, it is possible to achieve both a reduction in rolling resistance and a reduction in weight.

Further, by interposing only one inclined belt 50 A having the inclined cords 51 between the carcass 40 and the circumferential belt 50 B, the durability against a puncture is remarkably improved. Specifically, the propagation of a crack generated on the surface of the tread portion 20 by stepping on a foreign substance or the like is prevented by the inclined belt 50 A and does not reach the carcass 40. Thus, an air leak state in which air filled in the pneumatic tire 10 assembled to the rim wheel leaks can be avoided. Further, since there is only one inclined belt 50, the weight increase can be suppressed.

That is, according to the pneumatic tire 10, durability against puncture is improved while reducing rolling resistance and weight.

Since the thickness (gauge) of the tread portion 20 is thin, the growth (diameter growth) of the pneumatic tire 10 in the radial direction during traveling is suppressed. On the other hand, when the diameter growth is large, the ground contact area of the pneumatic tire 10 becomes small, and the grounding pressure becomes high. Therefore, when foreign substance or the like on the road surface is stepped on, the damage is large. In addition, the increase of the ground contacting pressure is not preferable from the viewpoint of wear resistance.

That is, the thin tread thickness T1 contributes to the improvement of durability including puncture.

The pneumatic tire 10 is a tire designed for use in light vehicles such as solar cars, and requires extremely low rolling resistance.

In order to minimize the rolling resistance of tire, it is important to minimize the distortion energy loss generated from the rubber member. It is necessary to minimize the amount of the rubber member used and to make the gauge thinner.

Further, when such a tire is used, the rolling resistance can be further reduced by using it at the highest internal pressure possible. For this reason, in tire which specializes in suppressing rolling resistance, a structure in which one layer of the carcass is provided with one layer of a spiral belt (reinforcement layer) has been widely used.

On the other hand, when the tire is used under high internal pressure, a large tension is applied to the rubber layer on the surface of the tire such as a tread. Therefore, when the surface of the tire is slightly damaged due to unevenness on the road surface, distortion is concentrated starting from the crack, and the crack easily develops in the rubber.

In this case, if the rubber thickness (rubber gauge) is thick, the tension tends to be released, and the progress of the crack in the rubber is relaxed. However, when the rubber gauge is thinned, a crack penetrates through the rubber layer and reaches the inner surface of the tire, and air leakage (puncture) occurs.

According to the pneumatic tire 10, the single inclined belt 50 A effectively suppresses the growth of such cracks, and enhances the durability against puncture with little sacrifice in other performance.

Further, if the tread thickness T1 is 1.5 mm or more and 3.5 mm or less, the rolling resistance can be further reduced while ensuring the durability against puncture. The maximum thickness T2 of the tire side portion 30 is 3 mm or less, and the maximum thickness T3 of the bead portion 60 is 13 mm or less. This can contribute to further reduction of rolling resistance.

In this embodiment, the inclination angle θ of the inclined cord 51 is 35 degrees or more and 55 degrees or less, preferably 40 degrees or more and 50 degrees or less. This can effectively prevent crack growth in the belt layer 50, specifically in tire width direction and tire circumferential direction. Thus, the durability against the puncture can be further improved.

In this embodiment, a bead-filler-less structure is adopted. Thus, the pneumatic tire 10 can be further reduced in weight. In consideration of the characteristics of the vehicle to which the pneumatic tire 10 is mounted, the required performance can be exhibited without providing a bead filler which is a rigid member of the bead portion 60.

In the present embodiment, the tan δ of the rubber forming the tread portion 20 at 30° C. is 0.08 to 0.2. Thus, the rolling resistance can be further reduced.

### (4) Other Embodiments

Although the contents of the present invention have been described above in accordance with the embodiments, it will be obvious to those skilled in the art that the present invention is not limited to these descriptions and that various modifications and improvements are possible.

For example, in the above embodiment, the pneumatic tire 10 has been described as being suitably usable for a solar car, but the pneumatic tire 10 may be mounted on a light vehicle other than a solar car, for example, a two-wheel automobile, a three-wheel automobile, a bicycle or the like mainly for high-speed traveling.

While embodiments of the invention have been described as above, it should not be understood that the statements and drawings which form part of this disclosure are intended to limit the invention. Various alternative embodiments, examples and operating techniques will become apparent to those skilled in the art from this disclosure.

### REFERENCE SIGNS LIST

10 pneumatic tire
20 tread portion
30 tire side portion
40 carcass
41 body portion
42 folded portion
43 carcass cord
50 belt layer
50 A inclined belt
50 B circumferential belt
51 inclined Cord
52 circumferential cord
60 bead portion
60 s space
61 bead core
70 chafer

1. A tire comprising:
a tread portion in contact with a road surface;
a tire side portion continuous to the tread portion and positioned inside in a tire radial direction of the tread portion;
a bead portion continues to the tire side portion and positioned inside in the tire radial direction of the tire side portion; and
a belt layer disposed inside the tire radial direction of the tread portion, wherein
the belt layer comprises:
a single inclined belt having an inclined cord inclined with respect to the tire width direction; and
a circumferential belt disposed outside the tire radial direction of the inclined belt and having a circumferential cord wound along the tire circumferential direction, wherein
the inclined cord and the circumferential cord are formed of a predetermined organic fiber, and
a tread thickness of a rubber forming the tread portion along a tire radial direction at a position of a tire equatorial line is 5 mm or less.

2. The tire according to claim 1, wherein the tread thickness is 1.5 mm or more and 3.5 mm or less.

3. The tire according to claim 1, wherein an inclination angle of the inclined cord with respect to the tire width direction is 35 degrees or more and 55 degrees or less, preferably 40 degrees or more and 50 degrees or less.

4. The tire according to claim 1, wherein a maximum thickness of the rubber constituting the tire side portion is 3 mm or less, and
a maximum thickness of the rubber constituting the bead portion is 13 mm or less.

5. The tire according to claim 1, the tire comprises a carcass forming the skeleton of the tire, wherein
the carcass comprises:
a body portion; and
a folded portion continuous to the body portion and folded back to outside in the tire width direction via a bead core,
the bead portion has a bead filler-less structure in which disposition of a bead filler between the body portion and the folded portion is omitted.

6. The tire according to claim 1, wherein tan δ at 30° C. of the rubber forming the tread portion is 0.08 or more and 0.2 or less.

7. The tire according to claim 2, wherein an inclination angle of the inclined cord with respect to the tire width direction is 35 degrees or more and 55 degrees or less, preferably 40 degrees or more and 50 degrees or less.

8. The tire according to claim 2, wherein a maximum thickness of the rubber constituting the tire side portion is 3 mm or less, and
a maximum thickness of the rubber constituting the bead portion is 13 mm or less.

9. The tire according to claim 3, wherein a maximum thickness of the rubber constituting the tire side portion is 3 mm or less, and
a maximum thickness of the rubber constituting the bead portion is 13 mm or less.

10. The tire according to claim 2, the tire comprises a carcass forming the skeleton of the tire, wherein
the carcass comprises:
a body portion; and
a folded portion continuous to the body portion and folded back to outside in the tire width direction via a bead core,
the bead portion has a bead filler-less structure in which disposition of a bead filler between the body portion and the folded portion is omitted.

11. The tire according to claim 3, the tire comprises a carcass forming the skeleton of the tire, wherein
the carcass comprises:
a body portion; and
a folded portion continuous to the body portion and folded back to outside in the tire width direction via a bead core,
the bead portion has a bead filler-less structure in which disposition of a bead filler between the body portion and the folded portion is omitted.

12. The tire according to claim 4, the tire comprises a carcass forming the skeleton of the tire, wherein
the carcass comprises:
a body portion; and
a folded portion continuous to the body portion and folded back to outside in the tire width direction via a bead core,
the bead portion has a bead filler-less structure in which disposition of a bead filler between the body portion and the folded portion is omitted.

13. The tire according to claim 2, wherein tan δ at 30° C. of the rubber forming the tread portion is 0.08 or more and 0.2 or less.

14. The tire according to claim 3, wherein tan δ at 30° C. of the rubber forming the tread portion is 0.08 or more and 0.2 or less.

15. The tire according to claim 4, wherein tan δ at 30° C. of the rubber forming the tread portion is 0.08 or more and 0.2 or less.

16. The tire according to claim 5, wherein tan δ at 30° C. of the rubber forming the tread portion is 0.08 or more and 0.2 or less.
